(19) United States
(12) Patent Application Publication
(10) Pub. No.: US 2009/0004455 A1
(43) Pub. Date: Jan. 1, 2009

(54) Reinforced composite implant

(76) Inventors: Philippe Gravagna, Irigny (FR); Yves Bayon, Lyon (FR); Dagmar Dassonville, Charnoz (FR); Alfredo Meneghin, Lyon (FR); Julie Lecuivre, Villefranche Sur Saone (FR)

Correspondence Address: CARTER, DELUCA, FARRELL & SCHMIDT, LLP, 445 BROAD HOLLOW ROAD, SUITE 420, MELVILLE, NY, 11747, US

(21) Appl. No.: 11/823,284

(22) Filed: Jun. 27, 2007

(51) Int. Cl. B32B 3/26

(52) U.S. Cl. 428/304.4

(57) ABSTRACT

Multilayer structures including a porous layer and a non-porous layer having a reinforcement member are useful as implants.

### TECHNICAL FIELD

The present composite materials have a non-porous layer, a porous layer and a reinforcement member. The present composite materials resist tearing when used in surgery and simultaneously achieve hemostasis and prevent post-surgical adhesion.

### DESCRIPTION OF THE RELATED ART

Implants for use in visceral surgery having a porous adhesive collagen layer closely associated with a collagen film are known. In this type of material, the film helps prevent the formation of post-operative adhesions and the porous adhesive collagen layer functions as a hemostatic compress.

Such implants are frequently secured to tissue during surgery using a surgical fastener, such as a staple, clip, tack, suture or the like. Collagen, however, weakens quickly when exposed to the moist conditions within the body during surgery. As a result, previous composite implants are prone to tearing during implantation.

It would be advantageous to provide an implant having both anti-adhesion and hemostatic properties and which resists tearing when subjected to the forces associated with securing the implant to tissue using surgical fasteners.

### SUMMARY

The present implants therefore aim to considerably improve the previously described composite collagenic materials with respect to their handling characteristics and resistance to tearing during implantation. These aims are achieved by the present implants which include a non-porous layer, a porous layer and a reinforcement member. In embodiments, the non-porous layer is a collagenic constituent-containing film possessing anti-adhesion properties. In embodiments, the porous layer is a collagenic constituent-containing foam that provides hemostatic properties. In embodiments, the reinforcement member is formed from fibers, such as, for example, monofilaments, multifilament braids, or staple fibers. In embodiments, the reinforcement member is a mesh.

Methods for producing the present implants are also described. In embodiments, a liquid solution based on a collagenic constituent destined to form the non-porous layer is cast on a substrate. The reinforcement member is applied to the solution, in embodiments becoming completely embedded therein, for example, by pressing the reinforcement member into the solution or by the application of additional solution on top of the original volume of solution. Prior to complete gelling, a pre-formed porous layer is laid on the surface of the gelling solution. Upon drying, the various components adhere to form the present implant.

### BRIEF DESCRIPTION OF THE DRAWINGS

FIG. 1 is a schematic illustration of a composite material in accordance with an embodiment the present disclosure.

### DETAILED DESCRIPTION OF PREFERRED EMBODIMENTS

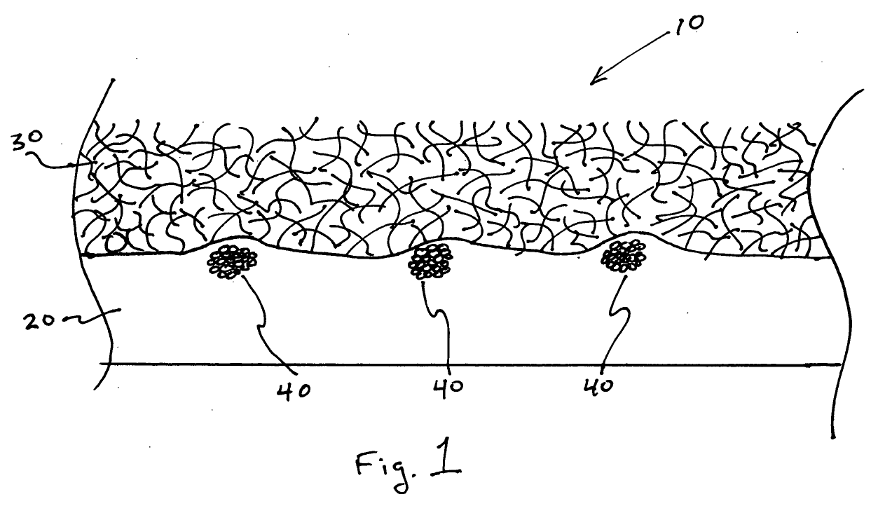

The present implants include a non-porous layer, a porous layer and a reinforcement member. As seen in FIG. 1, composite implant 10 includes non-porous layer 20, porous layer 30 and reinforcement members 40, which in this illustrative embodiment are multifilament yarns embedded within non-porous layer 20. Each of these layers and processes for preparing each layer and the composite implant are described in greater detail below.

### The Non-Porous Layer

The non-porous layer may retard or prevent tissue ingrowth from surrounding tissues thereby acting as an adhesion barrier and preventing the formation of unwanted scar tissue. Thus, in embodiments, the non-porous layer possesses anti-adhesion properties.

The non-porous layer of the present implant may be made from any biocompatible natural or synthetic material. The material from which the non-porous layer is formed may be bioabsorbable or non-bioabsorbable. It should of course be understood that any combination of natural, synthetic, bioabsorbable and non-bioabsorbable materials may be used to form the non-porous layer. Techniques for forming non-porous layers from such materials are within the purview of those skilled in the art and include, for example, casting, molding and the like.

Some non-limiting examples of materials from which the non-porous layer may be made include but are not limited to poly(lactic acid), poly(glycolic acid), poly(hydroxybutyrate), poly (phosphazine), polyesters, polyethylene glycols, polyethylene oxides, polyacrylamides, polyhydroxyethylmethylacrylate, polyvinylpyrrolidone, polyvinyl alcohols, polyacrylic acid, polyacetate, polycaprolactone, polypropylene, aliphatic polyesters, glycerols, poly(amino acids), copoly(ether-esters), polyalkylene oxalates, polyamides, poly(iminocarbonates), polyalkylene oxalates, polyoxaesters, polyorthoesters, polyphosphazenes and copolymers, block copolymers, homopolymers, blends and combinations thereof.

In embodiments, natural biological polymers are used in forming the non-porous layer of the implant. Suitable natural biological polymers include, but are not limited to, collagen, gelatin, fibrin, fibrinogen, elastin, keratin, albumin, hydroxyethyl cellulose, cellulose, oxidized cellulose, hydroxypropyl cellulose, carboxyethyl cellulose, carboxymethyl cellulose, and combinations thereof. In addition, the natural biological polymers may be combined with any of the other polymeric materials described herein to produce the non-porous layer of the implant.

In embodiments, an aqueous solution of a collagenic constituent is used to form the non-porous layer of the present implants. As used herein, the term “collagenic constituent” designates collagen which has at least partially lost its helical structure through heating or any other method, or gelatine. The term “gelatine” here includes commercial gelatine made of collagen which has been denatured by heating and in which the chains are at least partially hydrolyzed (molecular weight lower than 100 kDa). The collagenic constituent used may advantageously be formed of non-hydrolyzed collagen, mainly composed of α chains (molecular weight around 100 kDa). In the context of the present disclosure, α chains means complete α chains or fragments of these complete α chains produced by the loss of a small number of amino acids. The term “non-hydrolyzed” as used herein means that less than 10% of the collagenic chains have a molecular weight below about 100 kDa. If heating is used to denature the helical structure of the collagen, the heating should be moderate and provided under gentle conditions so as to avoid degradation by hydrolytic cleavage of the gelatine thus formed. Suitable gelatine materials are commercially available.

The collagen used can be of human or animal origin. It may particularly be type I porcine or bovine collagen, or type I or type III human collagen or mixtures in any proportions of the last two types. Native collagen may advantageously be used, in acid solution or after processing, to eliminate the telopeptides, notably by pepsin digestion. The collagen can also be modified by oxidative cleavage using any technique know to those skilled in the art, including, but not limited to the use of periodic acid or one of its salts as described by Tardy et al. in U.S. Pat. No. 4,931,546. Briefly, this technique involves mixing the collagen in acid solution with a solution of periodic acid or one of its salts at a concentration of between 1 and 10⁻⁵ M, in embodiments between 5 10⁻³ and 10⁻¹ M, at a temperature of between 10 and 25° C. for 10 minutes to 72 hours. This process breaks down hydroxylysine and the sugars of the collagen, thus creating reactive sites without causing crosslinking. The oxidative cleavage of collagen allows moderate cross-linking later in the collagenic material. It should of course be understood that this function may be provided by other means of moderate cross-linking, for example by beta or gamma irradiation, or other agents of moderate cross-linking, for example chemical reagents at suitably low and non-toxic doses.

In embodiments, the non-porous layer of the composite material according to the present disclosure is made of collagen which is oxidized or a mixture in any proportions of non-oxidized and oxidized collagens.

In embodiments, a solution of collagenic constituent as defined above is used to form the non-porous layer. Typically, a collagen concentration from about 5 g/l to about 50 g/l, in embodiments from about 25 g/l to about 35 g/l is used.

The solution of oxidized collagen, non-oxidized collagen or a mixture thereof, thus prepared, may be heated, for example to a temperature in excess of 37° C., in embodiments to a temperature of between 40 and 50° C., for at least one hour. This results in at least partial denaturing of the collagen's helical structure. Other physical or chemical techniques for denaturing collagen (e.g., ultrasonication, or by the addition of chaotropic agents) are within the purview of those skilled in the art may also be used.

In embodiments, at least one macromolecular hydrophilic additive that is chemically unreactive with the collagenic constituent may be added to the solution used to form the non-porous layer. “Chemically unreactive with the collagenic constituent” as used herein means a hydrophilic compound which is not likely to react with the collagenic constituent, notably which does not form covalent bonds with it during cross-linking.

The macromolecular hydrophilic additive advantageously has a molecular weight in excess of 3,000 Daltons, in embodiments from about 3,000 to about 20,000 Daltons. Illustrative examples of suitable macromolecular hydrophilic additives include polyalkylene glycols (such as polyethylene glycol), polysaccharides (e.g., starch, dextran and/or cellulose), oxidized polysaccharides, and mucopolysaccharides. It should of course be understood that combinations of macromolecular hydrophilic additives may be used. The concentration of hydrophilic additive(s) can typically be from about 2 to about 10 times less than that of the collagenic constituent.

Typically, the macromolecular hydrophilic additive is eliminated by diffusion through the non-porous layer, in a few days. The swelling of this material may advantageously promote degradation of a collagenic non-porous layer in less than a month.

Optionally, glycerine may be added to the solution used to form the non-porous layer. When present, the concentration of glycerine in the solution can typically be from about 2 to about 10 times less than that of the collagenic constituent, in embodiments less than about one-third of the collagenic constituent concentration.

In illustrative embodiments of the solution used to form the non-porous layer, the concentrations of collagenic constituent, hydrophilic additive(s) and glycerine, when present, can be from about 2 to about 10% for the collagenic constituent, from about 0.6 to about 4% for the hydrophilic additive(s) and from about 0.3 to about 2.5% for glycerine, respectively.

The solution used to form the non-porous layer may be prepared by adding collagenic constituent, hydrophilic additive(s) and glycerine, when present, to water or a water/alcohol (e.g., ethanol) mixture at a temperature of 30 to 50° C. The solution may advantageously be neutralized to a neutral pH to avoid hydrolyzing the collagenic constituent by heating and to obtain a film of physiological pH while permitting pre-cross-linking of the collagenic constituent if the mixture contains oxidized collagen as indicated previously.

### The Porous Layer

The porous layer of the implant has openings or pores over at least a portion of a surface thereof. As described in more detail below, suitable materials for forming the porous layer include, but are not limited to foams (e.g., open or closed cell foams). In embodiments, the pores may be in sufficient number and size so as to interconnect across the entire thickness of the porous layer. In other embodiments, the pores do not interconnect across the entire thickness of the porous layer. Closed cell foams are illustrative examples of structures in which the pores may not interconnect across the entire thickness of the porous layer. In yet other embodiments, the pores do not extend across the entire thickness of the porous layer, but rather are present at a portion of the surface thereof. In embodiments, the openings or pores are located on a portion of the surface of the porous layer, with other portions of the porous layer having a non-porous texture. Those skilled in the art reading the present disclosure will envision other pore distribution patterns and configurations for the porous layer.

The porous layer of the present implant may be made from any biocompatible natural or synthetic material. The material from which the porous layer is formed may be bioabsorbable or non-bioabsorbable. It should of course be understood that any combination of natural, synthetic, bioabsorbable and non-bioabsorbable materials may be used to form the porous layer. Some non-limiting examples of materials from which the porous layer may be made include but are not limited to poly(lactic acid), poly(glycolic acid), poly(hydroxybutyrate), poly(phosphazine), polyesters, polyethylene glycols, polyethylene oxides, polyacrylamides, polyhydroxyethylmethylacrylate, polyvinylpyrrolidone, polyvinyl alcohols, polyacrylic acid, polyacetate, polycaprolactone, polypropylene, aliphatic polyesters, glycerols, poly(amino acids), copoly(ether-esters), polyalkylene oxalates, polyamides, poly(iminocarbonates), polyalkylene oxalates, polyoxaesters, polyorthoesters, polyphosphazenes and copolymers, block copolymers, homopolymers, blends and combinations thereof. In embodiments, natural biological polymers are used in forming the porous layer of the implant. Suitable natural biological polymers include, but are not limited to, collagen, gelatin, fibrin, fibrinogen, elastin, keratin, albumin, hydroxyethyl cellulose, cellulose, hydroxypropyl cellulose, carboxyethyl cellulose, and combinations thereof. Alternatively, the polymer constituent may be a polysaccharide, or polysaccharides modified by oxidation of alcohol functions into carboxylic functions such as oxidized cellulose. In addition, the natural biological polymers may be combined with any of the other polymeric materials described herein to produce the porous layer of the implant.

Where the porous layer is a foam, the porous layer may be formed using any method suitable to forming a foam or sponge including, but not limited to the lyophilization or freeze-drying of a composition. Suitable techniques for making foams are within the purview of those skilled in the art.

The porous layer can be at least 0.1 cm thick, in embodiments from about 0.2 to about 1.5 cm thick. The porous layer can have a density of not more than about 75 mg collagen/cm² and, in embodiments below about 7 mg collagen/cm². The size of the pores in the porous layer can be from about 20 μm to about 300 μm, in embodiments from about 100 μm to about 200 μm.

In embodiments, the porous layer possesses haemostatic properties. Illustrative examples of materials which may be used in providing the porous layer with the capacity to assist in stopping bleeding or hemorrhage include, but are not limited to, poly(lactic acid), poly(glycolic acid), poly(hydroxybutyrate), poly(caprolactone), poly(dioxanone), polyalkyleneoxides, copoly(ether-esters), collagen, gelatin, thrombin, fibrin, fibrinogen, fibronectin, elastin, albumin, hemoglobin, ovalbumin, polysaccharides, hyaluronic acid, chondroitin sulfate, hydroxyethyl starch, hydroxyethyl cellulose, cellulose, oxidized cellulose, hydroxypropyl cellulose, carboxyethyl cellulose, carboxymethyl cellulose, agarose, maltose, maltodextrin, alginate, clotting factors, methacrylate, polyurethanes, cyanoacrylates, platelet agonists, vasoconstrictors, alum, calcium, RGD peptides, proteins, protamine sulfate, epsilon amino caproic acid, ferric sulfate, ferric subsulfates, ferric chloride, zinc, zinc chloride, aluminum chloride, aluminum sulfates, aluminum acetates, permanganates, tannins, bone wax, polyethylene glycols fucans and combinations thereof.

The haemostatic agents from which the porous layer can be made or which can be included in the porous layer can be in the form of foams, fibers, filaments, meshes, woven and non-woven webs, compresses, pads, powders, flakes, particles and combinations thereof. For example, the implant may include commercially available types of hemostatic porous layers, such as materials based on oxidized cellulose (Surgicel® or Interceed®).

In embodiments, the porous layer is a made from non-denatured collagen or collagen which has at least partially lost its helical structure through heating or any other method, consisting mainly of non-hydrolyzed α chains, of molecular weight close to 100 kDa. The term “non-denatured collagen” means collagen which has not lost its helical structure. The collagen used for the porous layer of present implant may be native collagen or atelocollagen, notably as obtained through pepsin digestion and/or after moderate heating as defined previously. The collagen may have been previously chemically modified by oxidation, methylation, ethylation, succinylation or any other known process. The origin and type of collagen may be as indicated for the non-porous layer described above.

In embodiments, the porous layer can be obtained by freeze-drying an aqueous acid solution of collagen at a concentration of 2 to 50 g/l and an initial temperature of 4 to 25° C. The concentration of collagen in the solution can be from about 1 g/l to about 30 g/l, in embodiments about 10 g/l. This solution is advantageously neutralized to a pH of around 6 to 8.

The porous layer can also be obtained by freeze-drying a fluid foam prepared from a solution of collagen or heated collagen, emulsified in the presence of a volume of air in variable respective quantities (volume of air:water varying from about 1 to about 10).

### The Reinforcement Member

The present implant also includes a reinforcement member. The reinforcement member may be positioned between the non-porous layer and the porous layer of the implant. Alternatively, the reinforcement member may be positioned entirely within the non-porous layer. It is also envisioned that the reinforcement member may be positioned at the surface of one of the layers making up the multilayer implant and, in embodiments, may be positioned at an exterior surface of the multilayer implant.

Some suitable non-limiting examples of the reinforcement member include fabrics, meshes, monofilaments, multifilament braids, chopped fibers (sometimes referred to in the art as staple fibers) and combinations thereof.

Where the reinforcement member is a mesh, it may be prepared using any technique known to those skilled in the art, such as knitting, weaving, tatting, knipling or the like. Illustrative examples of suitable meshes include any of those that are presently commercially available for hernia repair. In embodiments where a mesh is used as the reinforcement member, the mesh will aid in affixing the composite to tissue without tearing of the porous or non-porous layers.

Where monofilaments or multifilament braids are used as the reinforcement member, the monofilaments or multifilament braids may be oriented in any desired manner. For example, the monofilaments or multifilament braids may be randomly positioned with respect to each other within the implant structure. As another example, the monofilaments or multifilament braids may be oriented in a common direction within the implant. In embodiments, monofilaments or multifilament braids are associated with both the porous layer and with the non-porous layer. In an illustrative embodiment of this type, the implant includes a first reinforcement member having a plurality of reinforcement members oriented in a first direction within the non-porous layer and a second reinforcement layer having a plurality of reinforcement members oriented in a second direction within the porous layer. In embodiments, the first and second directions may be substantially perpendicular to each other.

Where chopped fibers are used as the reinforcement member, the chopped fibers may be oriented in any desired manner. For example, the chopped fibers may be randomly oriented or may be oriented in a common direction. The chopped fibers can thus form a non-woven material, such as a mat or a felt. The chopped fibers may be joined together (e.g., by heat fusing) or they may be unattached to each other. The chopped fibers may be of any suitable length. For example, the chopped may be from 0.1 mm to 100 mm in length, in embodiments, 0.4 mm to 50 mm in length. In an illustrative embodiment, the implant has randomly oriented chopped fibers that have not been previously fused together embedded within in the non-porous layer.

It is envisioned that the reinforcement member may be formed from any bioabsorbable, non-bioabsorbable, natural, and synthetic material previously described herein including derivatives, salts and combinations thereof. In particularly useful embodiments, the reinforcement member may be made from a non-bioabsorbable material to provide long term flexible tissue support. In embodiments, the reinforcement member is a surgical mesh made from polypropylene or polylactic acid. In addition polyethylene materials may also be incorporated into the implant described herein to add stiffness. Where monofilaments or multifilament braids are used as the reinforcement member, any commercially available suture material may advantageously be employed as the reinforcement member.

### Optional Bioactive Agents

In some embodiments, at least one bioactive agent may be combined with the implant and/or any of the individual components (the porous layer, the non-porous layer and/or the reinforcement member) used to construct the implant. In these embodiments, the implant can also serve as a vehicle for delivery of the bioactive agent. The term “bioactive agent”, as used herein, is used in its broadest sense and includes any substance or mixture of substances that have clinical use. Consequently, bioactive agents may or may not have pharmacological activity per se, e.g., a dye, or fragrance. Alternatively a bioactive agent could be any agent which provides a therapeutic or prophylactic effect, a compound that affects or participates in tissue growth, cell growth, cell differentiation, an anti-adhesive compound, a compound that may be able to invoke a biological action such as an immune response, or could play any other role in one or more biological processes. It is envisioned that the bioactive agent may be applied to the medial device in any suitable form of matter, e.g., films, powders, liquids, gels and the like.

Examples of classes of bioactive agents which may be utilized in accordance with the present disclosure include anti-adhesives, antimicrobials, analgesics, antipyretics, anesthetics, antiepileptics, antihistamines, anti-inflammatories, cardiovascular drugs, diagnostic agents, sympathomimetics, cholinomimetics, antimuscarinics, antispasmodics, hormones, growth factors, muscle relaxants, adrenergic neuron blockers, antineoplastics, immunogenic agents, immunosuppressants, gastrointestinal drugs, diuretics, steroids, lipids, lipopolysaccharides, polysaccharides, and enzymes. It is also intended that combinations of bioactive agents may be used.

Anti-adhesive agents can be used to prevent adhesions from forming between the implantable medical device and the surrounding tissues opposite the target tissue. In addition, anti-adhesive agents may be used to prevent adhesions from forming between the coated implantable medical device and the packaging material. Some examples of these agents include, but are not limited to poly(vinyl pyrrolidone), carboxymethyl cellulose, hyaluronic acid, polyethylene oxide, poly vinyl alcohols and combinations thereof.

Suitable antimicrobial agents which may be included as a bioactive agent in the bioactive coating of the present disclosure include triclosan, also known as 2,4,4′-trichloro-2′-hydroxydiphenyl ether, chlorhexidine and its salts, including chlorhexidine acetate, chlorhexidine gluconate, chlorhexidine hydrochloride, and chlorhexidine sulfate, silver and its salts, including silver acetate, silver benzoate, silver carbonate, silver citrate, silver iodate, silver iodide, silver lactate, silver laurate, silver nitrate, silver oxide, silver palmitate, silver protein, and silver sulfadiazine, polymyxin, tetracycline, aminoglycosides, such as tobramycin and gentamicin, rifampicin, bacitracin, neomycin, chloramphenicol, miconazole, quinolones such as oxolinic acid, norfloxacin, nalidixic acid, pefloxacin, enoxacin and ciprofloxacin, penicillins such as oxacillin and pipracil, nonoxynol 9, fusidic acid, cephalosporins, and combinations thereof. In addition, antimicrobial proteins and peptides such as bovine lactoferrin and lactoferricin B and antimicrobial polysaccharides such as fucans and derivatives may be included as a bioactive agent in the bioactive coating of the present disclosure.

Other bioactive agents which may be included as a bioactive agent in the coating composition applied in accordance with the present disclosure include: local anesthetics; non-steroidal antifertility agents; parasympathomimetic agents; psychotherapeutic agents; tranquilizers; decongestants; sedative hypnotics; steroids; sulfonamides; sympathomimetic agents; vaccines; vitamins; antimalarials; anti-migraine agents; anti-parkinson agents such as L-dopa; anti-spasmodics; anticholinergic agents (e.g. oxybutynin); antitussives; bronchodilators; cardiovascular agents such as coronary vasodilators and nitroglycerin; alkaloids; analgesics; narcotics such as codeine, dihydrocodeinone, meperidine, morphine and the like; non-narcotics such as salicylates, aspirin, acetaminophen, d-propoxyphene and the like; opioid receptor antagonists, such as naltrexone and naloxone; anti-cancer agents; anti-convulsants; anti-emetics; antihistamines; anti-inflammatory agents such as hormonal agents, hydrocortisone, prednisolone, prednisone, non-hormonal agents, allopurinol, indomethacin, phenylbutazone and the like; prostaglandins and cytotoxic drugs; estrogens; antibacterials; antibiotics; anti-fungals; anti-virals; anticoagulants; anticonvulsants; antidepressants; antihistamines; and immunological agents.

Other examples of suitable bioactive agents which may be included in the coating composition include viruses and cells, peptides, polypeptides and proteins, analogs, muteins, and active fragments thereof, such as immunoglobulins, antibodies, cytokines (e.g. lymphokines, monokines, chemokines), blood clotting factors, hemopoietic factors, interleukins (IL-2, IL-3, IL-4, IL-6), interferons ((3-IFN, (a-IFN and y-IFN), erythropoietin, nucleases, tumor necrosis factor, colony stimulating factors (e.g., GCSF, GM-CSF, MCSF), insulin, anti-tumor agents and tumor suppressors, blood proteins, gonadotropins (e.g., FSH, LH, CG, etc.), hormones and hormone analogs (e.g., growth hormone), vaccines (e.g., tumoral, bacterial and viral antigens); somatostatin; antigens; blood coagulation factors; growth factors (e.g., nerve growth factor, insulin-like growth factor); protein inhibitors, protein antagonists, and protein agonists; nucleic acids, such as antisense molecules, DNA and RNA; oligonucleotides; polynucleotides; and ribozymes.

### Assembling the Implant

The multilayer implant material described herein may be formed using any method known to those skilled in the art capable of connecting a non-porous layer to a porous layer. It is envisioned that the non-porous layer and the porous layer may be adhered to one another using chemical bonding, surgical adhesives, surgical sealants, and surgical glues. In addition, the layers may be bound together using mechanic means such as pins, rods, screws, clips, etc. Still further, the layers may naturally or through chemical or photoinitiation may interact and crosslink or provide covalent bonding between the layers.

In embodiments, the multilayer implant described herein is prepared by attaching the individual layers of materials together to form a multiple layer implant. The porous layer may be formed separate and apart from the non-porous layer. Alternatively, the porous and non-porous layers may be formed together.

In an illustrative embodiment, the implant is prepared by first pouring a solution of collagenic constituent, destined to form the film, possibly containing the hydrophilic additive(s) and glycerine, onto an adequate, substantially flat support and distributing it evenly.

The support is inert in that it does not react with the above-mentioned components and is not involved in the cross-linking process. The support may advantageously be made from a hydrophobic material such as, for example, PVC or polystyrene. However, this support can also consist of a strippable material which will remain slightly adhesive and which can then be separated from the implant at the time of surgical use. This support may itself also consist of a film, for example dried collagen, onto which the solution is poured, or a layer of collagenic material gel in a distinctly more advanced state of gelification.

The density of the thin layer initially applied as a solution to the substrate can be from about 0.1 g solution/cm² to about 0.3 g solution/cm². This collagenic solution advantageously may be poured at a temperature from about 4° C. to about 30° C., and in embodiments from about 18° C. to about 25° C. Once applied to the substrate, the collagen solution is allowed to partially gel. Partial gelling results from cooling of the collagen solution, and not from drying of the solution.

A mesh reinforcement member is then applied to the solution. Application of the reinforcement member onto the solution means simply laying the reinforcement member onto the solution or partially gelled solution, and optionally applying slight pressing. The pressing should be insufficient to cause any significant disruption of the portion of the layer of solution in contact with the substrate thereby helping to maintain the integrity and anti-adhesion characteristics of the non-porous layer. The pressing may leave the surface of the reinforcement member exposed at the surface of the solution or may embed the reinforcement member completely within the layer of solution.

Following application of the mesh reinforcement member, but before complete gellification of the initially applied solution, additional solution may be applied in an amount sufficient to cover the mesh, so that it is completely embedded within the solution. Where pressing has already embedded the reinforcement member in the solution, application of additional solution may be eliminated.

This solution containing the embedded mesh reinforcement member is left to gel and a porous layer prepared as indicated above is applied to the solution during gelification.

Application of the porous layer onto the solution during gelification means simply laying the porous layer onto the gel, and optionally applying slight pressing. The pressing should be insufficient to cause any significant compaction of the porous layer. In embodiments where the porous layer has been pre-formed, the porous layer will become joined to the solution, but will not become interlocked with the mesh reinforcement member.

The moment at which the porous layer is applied to the solution during gelification will depend upon the nature of the solution employed, the conditions under which the solution is maintained during gelification and the nature of the porous layer. Generally, the solution will allowed to gellify for a period of time prior to application of the porous layer such that the gel is still soft and allows the porous layer to penetrate over a distance which is advantageously from about 0.01 mm to about 2 mm and, in embodiments from about around 0.1 mm to about 0.5 mm. The appropriate moment for application of the porous layer for any given combination of materials/conditions can be determined empirically, for example by applying small samples of the porous layer to the gel at various times and evaluating the degree of penetration and adherence. Generally, when the solution which is gelling is at a temperature of between 4 and 30° C., the porous layer can be applied 5 to 30 minutes after the solution has been poured over the surface holding it.

The composite implant is left to dry or dried in order to obtain the final implant. When the collagenic solution destined to form the film includes oxidized collagen, it is polymerized while the material is drying. This drying occurs favorably at a temperature of from about 4° C. to about 30° C., in embodiments from about 18° C. to about 25° C. The material can be dried in a jet of sterile air if desired.

After drying, the implant can be separated from its support, packaged and sterilized using conventional techniques, e.g., irradiation with beta (electronic irradiation) or gamma (irradiation using radioactive cobalt) rays. In embodiments where hydrolytically unstable materials are used in forming the composite, such as polyglycolic acid, polylactic acid the composites are packaged under sufficiently dry conditions to ensure that no degradation of the composite takes place during storage.

The present implants are stable at ambient temperature and remains stable for long enough to be handled at temperatures which may rise to 37-40° C. The thickness of the non-porous layer is not critical, but typically can be less than about 100 [,m thick, and in embodiments from about 30 Rm. to about 75 [tm thick. Likewise, the thickness of the porous layer is not critical, but typically can be from about 0.2 cm to about 1.5 cm thick, and in embodiments from about 0.3 cm to about 1.2 cm thick. The implants in accordance with this disclosure can be produced at a desired size or produced in large sheets and cut to sizes appropriate for the envisaged application.

The present composites may be implanted using open surgery or in a laparoscopic procedure. When implanted laparoscopically, the composite implant should be rolled with the porous side on the inside before trocar insertion.

The porous layer of the present implant can act as a local hemostatic, which can be applied with pressure to the site of haemorrhage until hemostasis is obtained. Blood is absorbed by the porous layer of material and concentrated under the material with the non-porous layer acting as a seal or barrier. The implant very quickly adheres to a bleeding wound, through the formation of a hemostatic plug and/or clot by the polymer. It is thought that excellent hemostatic properties may be due to the implant's ability to absorb a large quantity of blood while preventing it from spreading either transversally or in the plane of the implant. In addition, the diffusion of blood through the porous layer, within the area marked by the wound, increases the area of contact between the hemostatic substance and the platelets, thereby accelerating hemostasis by playing on the various ways of obtaining coagulation, the final phase of which leads to the formation of a network of platelets and fibrin reinforcing the implant's adhesion to the wound. The porous structure promotes rapid cellular colonization.

On the other hand, the implants described herein are particularly suitable for preventing post-operative adhesion, particularly in bleeding wounds, because the film prevents adherence. The non-porous layer also protects the healing wound for several days as it forms a barrier to bacteria and micro-organisms.

In embodiments where a mesh is used as the reinforcement member, the mesh will aid in affixing the composite to tissue without tearing of the porous or non-porous layers. The composite may be affixed to tissue using any conventional fastener, such as, for example, sutures, staples, tacks, two part fasteners, and the like. In embodiments, the fastener used to affix the composite to tissue is bioabsorbable, providing securement of the composite to a desired location long enough for tissue ingrowth to occur.

### EXAMPLES

The following non-limiting examples show possible combinations of the materials and their hemostatic powers and ability to prevent post-operative tissue adhesions.

### Example 1

### Preparation of Porous Layer

Type I porcine collagen is extracted from pig dermis and rendered soluble through pepsin digestion and purified by saline precipitation using conventional techniques.

A 10 g/l solution of the collagen is prepared by dissolving 23 g of damp collagen (12% humidity) in 2070 g of ultrafiltered water, at an ambient temperature below 25° C. It is neutralized using sodium hydroxide to a neutral pH, which leads to precipitation of the collagen.

A porous layer suitable for use in making a multilayer buttress is prepared by pouring the neutralized 1% collagen suspension onto freeze-dry plates. The amount of collagen solution is 0.55 grams of suspension per square centimeter of the plate. The suspension is the freeze dried using conventional techniques in one cycle lasting less than 48 hours.

The lyophilized atelocollagen is then heated at 50° C. for a period lasting between 15 and 24 hours to improve the cohesion and mechanical resistance of the lyophilized product during assembly of the composite.

### Preparation of a Solution of Oxidized Collagen Used to Form a Non-Porous Film

Type I porcine collagen is extracted from pig dermis and rendered soluble through pepsin digestion and purified by saline precipitation using conventional techniques.

A 30 g/l solution of oxidized collagen used for this example, is prepared according to patent FR-A-2 715 309.

Dry collagen fibres are used for preference, obtained by precipitation of an acid solution of collagen by adding NaCl, then washing and drying the precipitate obtained using aqueous solutions of acetone in concentrations increasing from 80% to 100%.

A 30 g/l solution of collagen is prepared by dissolving it in 0.01 N HCl. Its volume is 49 liters. Periodic acid is added to it at a final concentration of 8 mM, i.e. 1.83 g/l. Oxidation takes place at an ambient temperature close to 22° C. for 3 hours away from light.

Then an equal volume of a solution of sodium chloride is added to the solution to obtain a final concentration of 41 g/l NaCl.

After waiting for 30 minutes, the precipitate is collected by decantation through a fabric filter, with a porosity close to 100 microns, then washed 4 times with a 41 g/l solution of NaCl in 0.01 N HCl. This produces 19 kg of acid saline precipitate. This washing process eliminates all traces of periodic acid or iodine derivatives during oxidation of the collagen.

Then, several washes in an aqueous solution of 80% acetone are used to concentrate the collagen precipitate and eliminate the salts present.

A final wash in 100% acetone is used to prepare 3.6 kg of a very dense acetone precipitate of acid, oxidized, non-reticulated collagen, with no trace of undesirable chemical products.

The acetone paste is diluted with apyrogenic distilled water at 40° C., to obtain a 3% concentration of collagen, for a volume of 44 liters. The collagen suspension of a volume of 44 liters is heated for 30 minutes at 50° C., then filtered under sterile conditions through a membrane of 0.45 micron porosity in a drying oven at 40° C.

As soon as this solution is homogeneous and at 35° C., a sterile concentrated solution of PEG 4000 (polyethylene glycol with a molecular weight of 4000 Daltons) and glycerine is added to it to produce a final concentration of 0.9% PEG, 0.54% glycerine and 2.7% oxidized collagen.

As soon as these additions have been made, the pH of the solution is adjusted to 7.0 by adding a concentrated solution of sodium hydroxide.

### Preparation of a Multilayer Buttress Material

An implant having a foam layer made from a composition that includes a collagenic constituent joined to a fiber-reinforced film made from a composition that includes a collagenic constituent is prepared. The collagen solution destined to form the non-porous layer, as described in above, is poured in a thin layer on a framed, flat hydrophobic support such as PVC or polystyrene, at an ambient temperature close to 22° C. The amount of solution used is 0.106 grams of solution per square centimeter of support. After one hour, a second layer of collagen is applied to the first layer in an amount of 0.041 grams solution per square centimeter of support. The second solution is prepared by diluting the first solution with ethyl alcohol and water to produce a final collagen concentration of 1.75% by weight.

Immediately after application of the second, diluted collagen solution, a knitted isoelastic, multifilament polyglycolic acid mesh reinforcement member is applied to the second collagen layer.

After one hour, the porous layer, prepared as described above, is applied uniformly to the mesh. This waiting time is the collagen solution gelling time, required for application of the porous layer, to prevent it dissolving or becoming partially hydrated in the liquid collagen. Penetration of the porous layer into the gelled collagen solution can be less than 0.5 mm.

The composite material is then dehydrated in a drying cabinet at 20° C. and 40% humidity with a horizontal flow of filtered air at a velocity of 1.2 m²/s.

### Example 2

### Preparation of a Multilayer Buttress Material

The collagen solution destined to form the non-porous, as described above in Example 1, is poured in a layer equal to about 0.133 g/cm² on a flat PVC support at an ambient temperature close to 22° C.

Immediately thereafter, a knitted isoelastic, multifilament polyglycolic acid mesh reinforcement member, is applied on the layer of collagen and completely embedded therein by gently pressing the mesh into the collagen solution.

After cooling for 45 minutes, the porous layer, prepared as described above in Example 1, is applied to the partially gelled collagen film.

The multilayer, reinforced buttress material is dried in a drying cabinet as described in Example 1 for between 14 and 16 hours.

It will be understood that various modifications may be made to the embodiments disclosed herein. Therefore, the above description should not be construed as limiting, but merely as an exemplification of preferred embodiments. Those skilled in the art will envision other modifications within the scope and spirit of the present disclosure. Such modifications and variations are intended to come within the scope of the following claims.

1. An implant comprising
a foam layer comprising a collagenic constituent joined to a fiber-reinforced film comprising from about 25% to about 90% collagen.

2-7. (canceled)

8. An implant as in claim 1 wherein the foam layer comprises Type I porcine collagen.

9. An implant as in claim 1 wherein the foam layer comprises lyophilized atelocollagen.

10. An implant as in claim 1 wherein the fiber reinforced film comprises a film reinforced with a mesh.

11. An implant as in claim 1 wherein the foam layer has haemostatic properties.

12. An implant as in claim 1 wherein the foam layer is at least about 0.1 cm thick.

13. An implant as in claim 1 wherein the foam layer is from about 0.2 to about 1.5 cm thick.

14. An implant as in claim 1 wherein the foam layer further comprises non-denatured collagen.

15. An implant as in claim 1 wherein the foam layer has a density less than about 75 mg collagen/cm².

16. An implant as in claim 1 wherein the foam layer has a density less than about 7 mg collagen/cm².

17. An implant as in claim 1 wherein the foam layer comprises open cell foam.

18. An implant as in claim 1 wherein the fiber-reinforced film comprises partially hydrolyzed collagen.

19. An implant as in claim 1 wherein the fiber-reinforced film comprises oxidized collagen.

21. An implant as in claim 1 wherein the fiber-reinforced film comprises a macromolecular hydrophilic additive.

22. An implant as in claim 1 wherein the fiber-reinforced film comprises glycerine.

23. An implant as in claim 1 wherein the fiber-reinforced film comprises cross-linked collagen.

24. An implant as in claim 1 wherein the fiber-reinforced film comprises a bioabsorbable reinforcement member.

25. An implant as in claim 1 wherein the fiber-reinforced film comprises a multifilament reinforcement member.

26. An implant as in claim 1 wherein the fiber-reinforced film comprises an anti-adhesive agent.
